(19) United States
(12) Patent Application Publication
(10) Pub. No.: US 2015/0029066 A1
(43) Pub. Date: Jan. 29, 2015

(54) SURROUNDED ANTENNA HAVING A PHASE SHIFTER THEREIN

(71) Applicant: Shun-Fu Technology Corp., Taipei City (TW)

(72) Inventor: Yung-Sheng HUANG, Taipei City (TW)

(21) Appl. No.: 14/326,430

(22) Filed: Jul. 8, 2014

(30) Foreign Application Priority Data
Jul. 26, 2013 (TW) 102214103

(51) Int. Cl. H01Q 13/10

(52) U.S. Cl. CPC H01Q 13/106
USPC 343/767

(57) ABSTRACT

A surrounded antenna includes a radiation patch comprising a closed slot and a surface current path of a predetermined width surrounding the closed slot; a phase shifter comprising at least one short-circuit path (short stub) segment and at least one open path (open stub) segment, each short-circuit path (short stub) segment being connected between two internal contacts of the surface current path, each open path (open stub) segment comprising opposing connection end and open end, the connection end being to the surface current path; a grounded patch spaced apart from the radiation patch at a predetermined distance; and a feeding point located at one short-circuit path (short stub) segment and connected to the grounded patch through at least one hole. Thus, the phase shifter can offset the phase between surface current paths, achieving in-phase radio signal strength enhancement.

### BACKGROUND OF THE INVENTION

1. Field of the Invention

The present invention relates to antenna technology and more particularly, to a surrounded antenna, which comprises a phase shifter made in a predetermined pattern for easy identification and adapted for amplifying radio signal strength.

2. Description of the Related Art

Planar antenna structures in use today commonly comprises a radiation patch, a reflective (grounded) patch, a non-conductive dielectric material set between the radiation patch and the reflective (grounded) patch, and at least one metal wire inserted through at least one hole between the radiation patch and the reflective (grounded) patch for transmitting or receiving radio signals. When a radio signal between the radiation patch and the reflective (grounded) patch reaches the expected resonance frequency, the radio signal is transmitted or received.

In known microstrip antenna (MSA) techniques, rectangular microstrip antennas (RMSA) and circular microstrip antennas (CMSA) are most frequently seen, wherein the widths of rectangular microstrip antennas are generally compatible with the wavelength of the frequency to enhance radiation, however, under the same design conditions, such as dielectric constant εr=1, this kind of microstrip antenna can simply achieve an antenna gain up only about 5 dBi.

In “Broadband Microstrip Antenna” of Girich Kumar, it is indicated that the use of an annular ring microstrip antenna can enhance antenna gain and also improve the entire antenna efficiency and the radiation efficiency, for example, the antenna gain can be up to 8˜9 dBi, and then antenna efficiency and radiation efficiency can be as high as over 90%.

In chapter 8 in “Broadband Microstrip Antenna” of Girich Kumar, making a slot in the radiation patch can increase the length of the surface current path to lower the resonance frequency; increasing the size of the slot facilitates the fabrication of a micro antenna. However, under the presence of a coaxial feeding point at a predetermined resistance value, the impedance matching cannot be achieved in any position, and a transformer in line with the wavelength of the frequency must be set in the slot in order to obtain the desired impedance matching.

As this kind of broadband microstrip antennas are widely used in communication products and equipments, the antennas themselves cannot transmit or receive signal through an extremely short transient period of pulse wave, restricting the range of applications. In Radio Frequency Identification (RFID), radio waves are used to transmit identification information. An RFID system normally consists of a reader and an RFID tag. The reader transmits a frequency to the RFID tag from a distance. The RFID tag contains electronically stored information, and acts as a passive transponder to emit an encoded radio signal for communication with the reader and for subsequent processing by the reader. Because the antenna cannot transmit or receive signal through an extremely short transient period of pulse wave, the communication between the reader and the RFID tag must be performed within a very short distance (the RFID tag must be kept in proximity to the reader). This, short distance of 13.56 MHz (HF) RFID cannot be used in a communication system of 900 MHz (UHF) RFID.

### SUMMARY OF THE INVENTION

The present invention has been accomplished under the circumstances in view. It is main object of the present invention to provide a surrounded antenna, which comprises a phase shifter adapted for amplifying radio signal strength, and can significantly improve the return loss, gain, antenna efficiency and radiation efficiency.

It is another object of the present invention to provide a surrounded antenna, which comprises a phase shifter made in a predetermined pattern (trademark or mark pattern) for easy identification.

To achieve these and other objects of the present invention, a surrounded antenna in accordance with the present invention comprises a radiation patch comprising a closed slot and a surface current path of a predetermined width surrounding the closed slot; a phase shifter comprising at least one short-circuit path (short stub) segment and at least one open path (open stub) segment, each short-circuit path (short stub) segment being connected between two internal contacts of the surface current path, each open path (open stub) segment comprising opposing connection end and open end, the connection end being to the surface current path; a grounded patch spaced apart from the radiation patch at a predetermined distance; and a feeding point located at one short-circuit path (short stub) segment and connected to the grounded patch through at least one hole.

Preferably, the connection end of each open path segment is connected to one internal contact of one short-circuit path (short stub) segment to which one short-circuit path (short stub) segment is connected.

Preferably, the connection end of each open path segment is selectively connected to one of a plurality of contacts of the surface current path.

Preferably, the connection end of each open path segment is selectively connected to one of a plurality of internal contacts of the short-circuit path (short stub) segment.

Preferably, the phase shifter constitutes an identification pattern layer in a predetermined pattern for identification.

Preferably, the identification pattern layer is formed of at least one short-circuit path (short stub) segment and at least one open path segment.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic top view of a radiation patch for surrounded antenna using a phase shifter for broadband application in accordance with the present invention.

FIG. 2 is an equivalent circuit diagram of the radiation patch shown in FIG. 1.

FIG. 3 is an oblique top elevational view of a surrounded antenna using a phase shifter for broadband application in accordance with the present invention.

FIG. 4 is an exploded view of the surrounded antenna shown in FIG. 3.

FIG. 5 is a return loss graph obtained from the surrounded antenna in accordance with the present invention.

FIG. 6 is an elevation pattern gain display obtained from the surrounded antenna in accordance with the present invention.

FIG. 7 an effective frequency table obtained from a surrounded antenna in accordance with the present invention.

FIG. 8 is an elevation pattern gain and frequency curve obtained from a surrounded antenna in accordance with the present invention.

### DETAILED DESCRIPTION OF THE PREFERRED EMBODIMENT

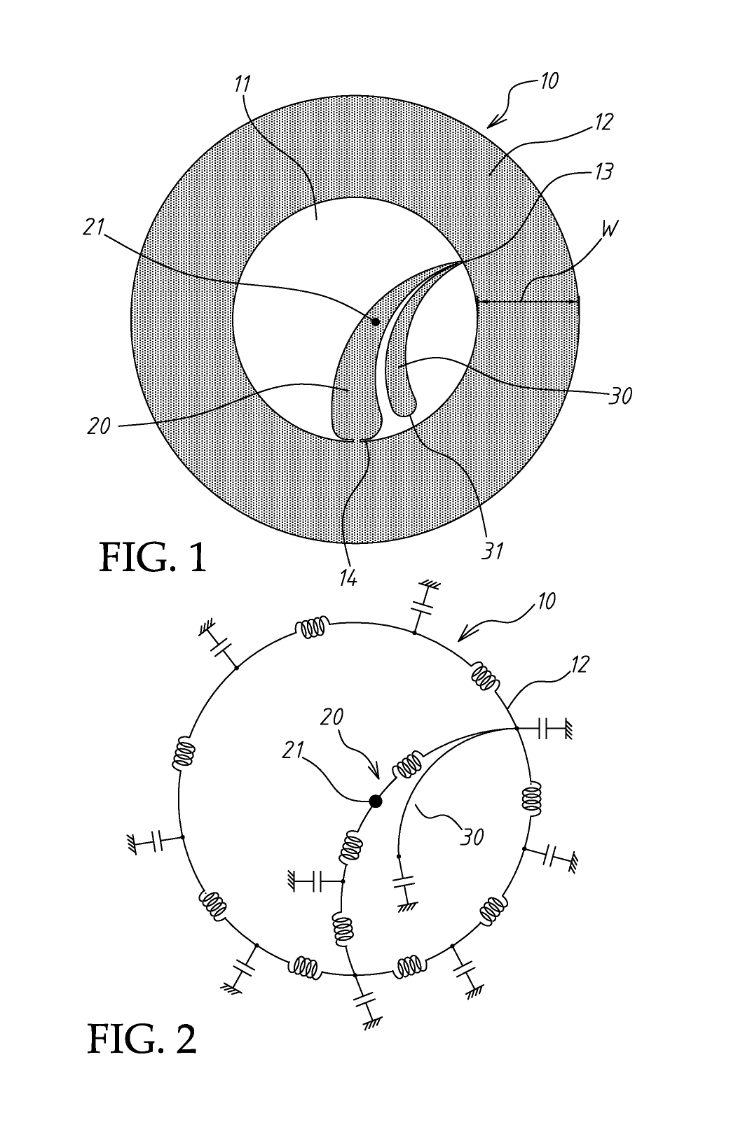

Referring to FIG. 1, a radiation patch 10 for a surrounded antenna using a phase shifter for broadband application in accordance with the present invention is shown. The radiation patch 10 in this embodiment is an annular patch. However, this annular configuration is not a limitation. Alternatively, the radiation patch 10 can be shaped like any polygon such as square, rectangle, triangle, etc.

The radiation patch 10 comprises a closed slot 11, and a surface current path 12 of a predetermined width W surrounding the closed slot 11. The size and shape of the closed slot 11 and the width W of the surface current path 12 can be adjusted according to the desired operating frequency (such as 900 MHz or 1800 MHz and its wavelength).

The radiation patch 10 further comprises a short-circuit path (short stub) segment 20 connected between two internal contacts 13;14 of the surface current path 12, and an open path (open stub) segment 30 that has one end (the connection end) thereof connected to one internal contact 13 of the surface current path 12 and an opposite end thereof terminating in an open end 31. The short-circuit path (short stub) segment 20 comprises a feeding point 21. FIG. 2 illustrates an equivalent circuit of the radiation patch 10 where capacitors are connected in series to inductive elements and grounded.

In this embodiment, the connection end (the end opposite to the open end 31) of the open path (open stub) segment 30 is connected to one internal contact 13 of the surface current path 12. However, this connection arrangement is not a limitation. Alternatively, the connection end (the end opposite to the open end 31) of the open path (open stub) segment 30 can be connected to any other point of the surface current path 12. Thus, the short-circuit path (short stub) segment 20 and the open path (open stub) segment 30 constitute a phase shifter in a predetermined pattern. In this embodiment, the pattern is shaped like a water-drop.

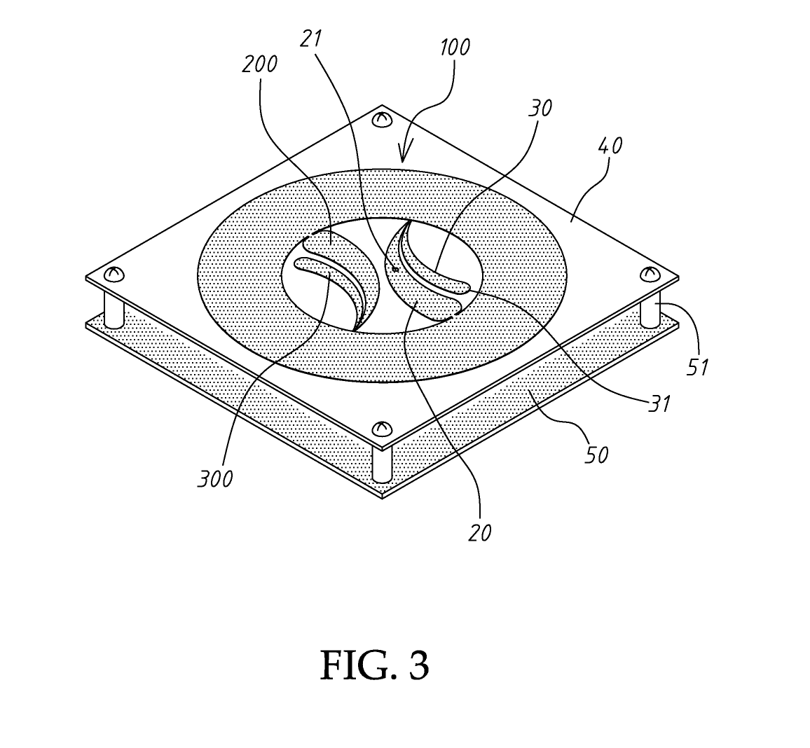

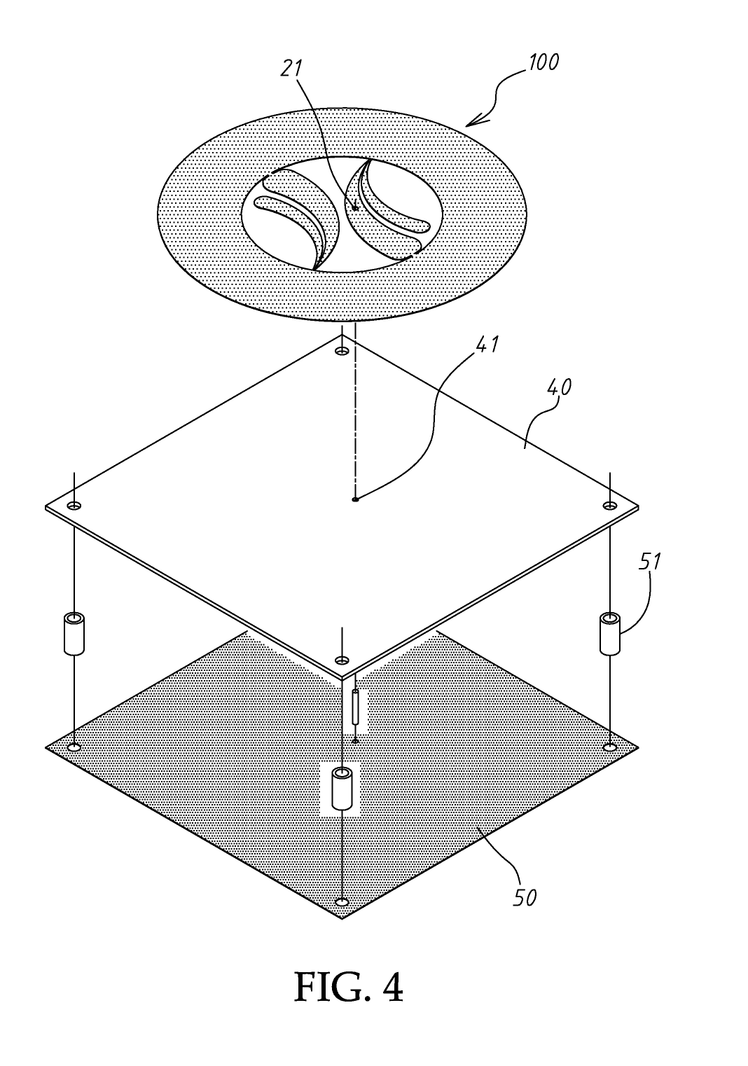

The diameter (or size) of the radiation patch 10, the size and shape of the closed slot 11, the width W of the surface current path 12 and the size and shape of the phase shifter can be adjusted subject to the operating frequency. FIGS. 3 and 4 illustrate an alternate form of the present invention. In this alternate form, the radiation patch, referenced by 100, comprises two short-circuit path (short stub) segments 20;200 and two open path (open stub) segments 30;300 that respectively constitute a respective phase shifter in a predetermined pattern, for example, water-drop pattern. These two phase shifters are arranged in a symmetric manner.

In the embodiment shown in FIGS. 3 and 4, the aforesaid radiation patch 100 is formed on the surface of a substrate 40 via laser or etching methods; a grounded patch 50 is kept apart from the substrate 40 at a predetermined distance such that the feeding point 21 can be connected to the grounded patch 50 through at least one hole 41 in the substrate 40. Further, a plurality of columns 51 are arranged between the substrate 40 and the grounded patch 50 to define the distance therebetween.

The one or multiple phase shifters of the present invention can offset the phase between surface current paths, achieving in-phase radio signal strength enhancement.

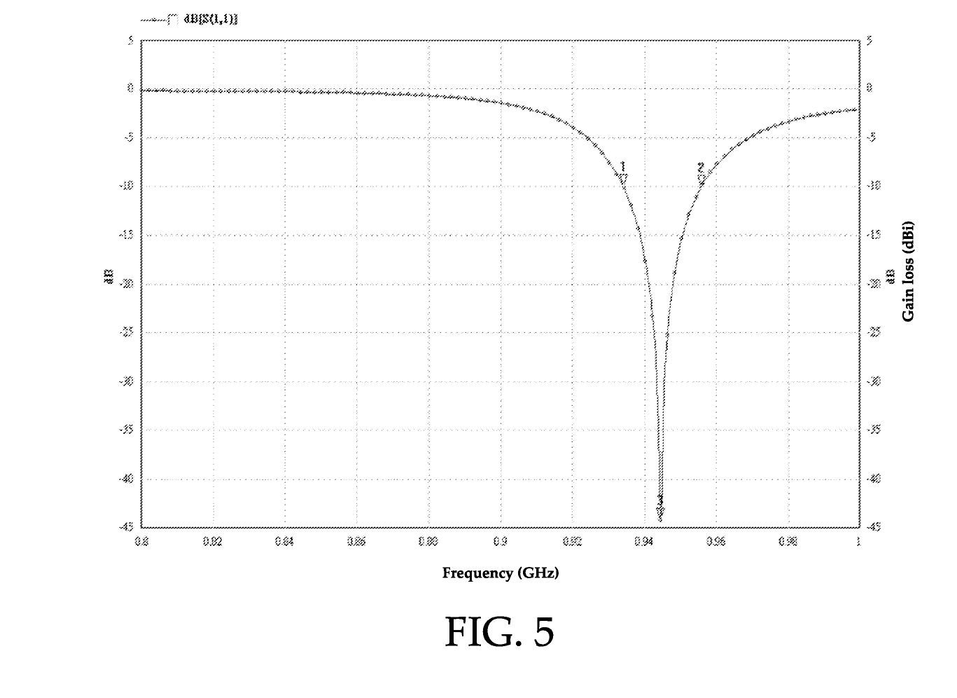

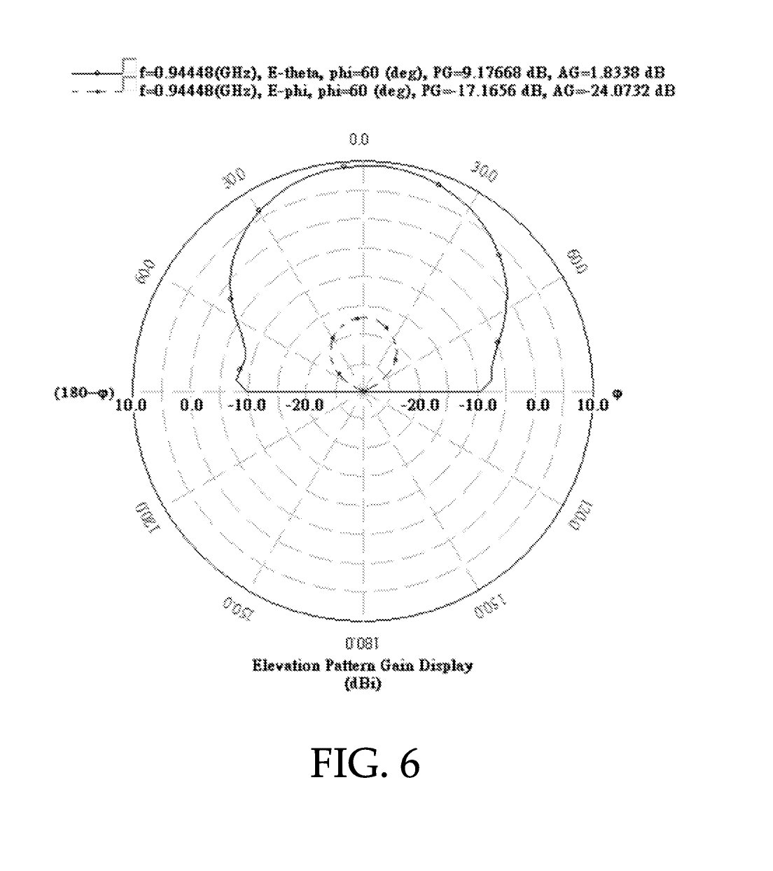

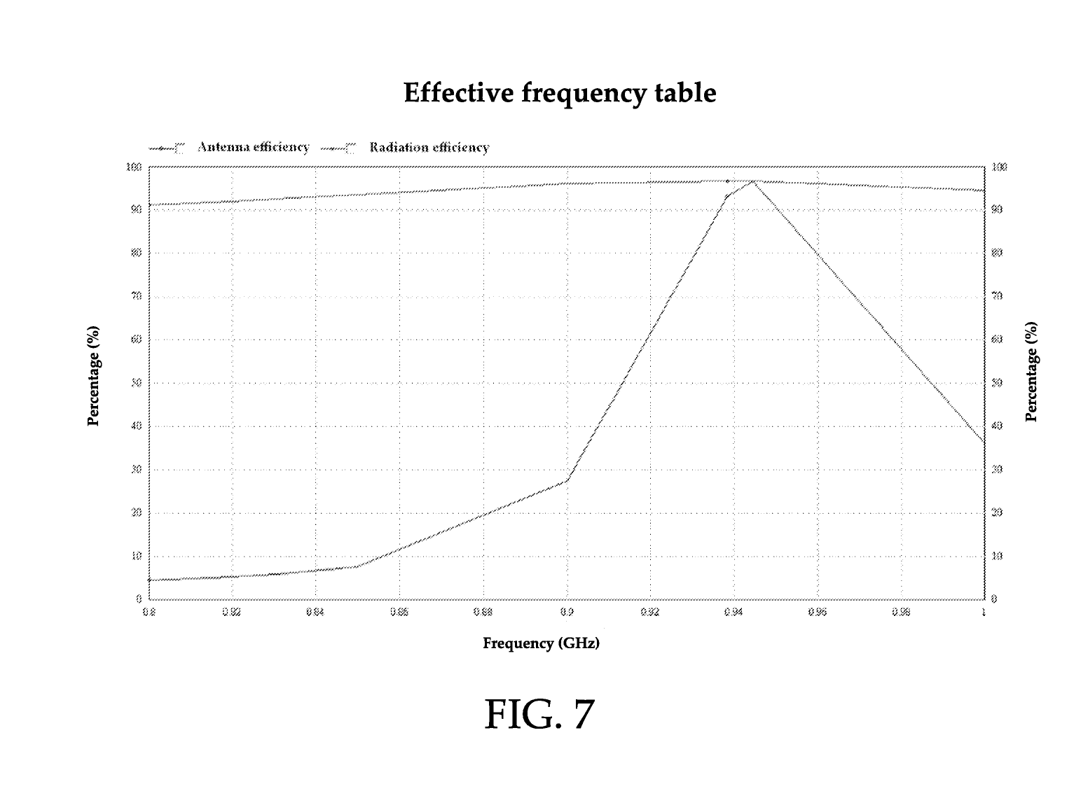

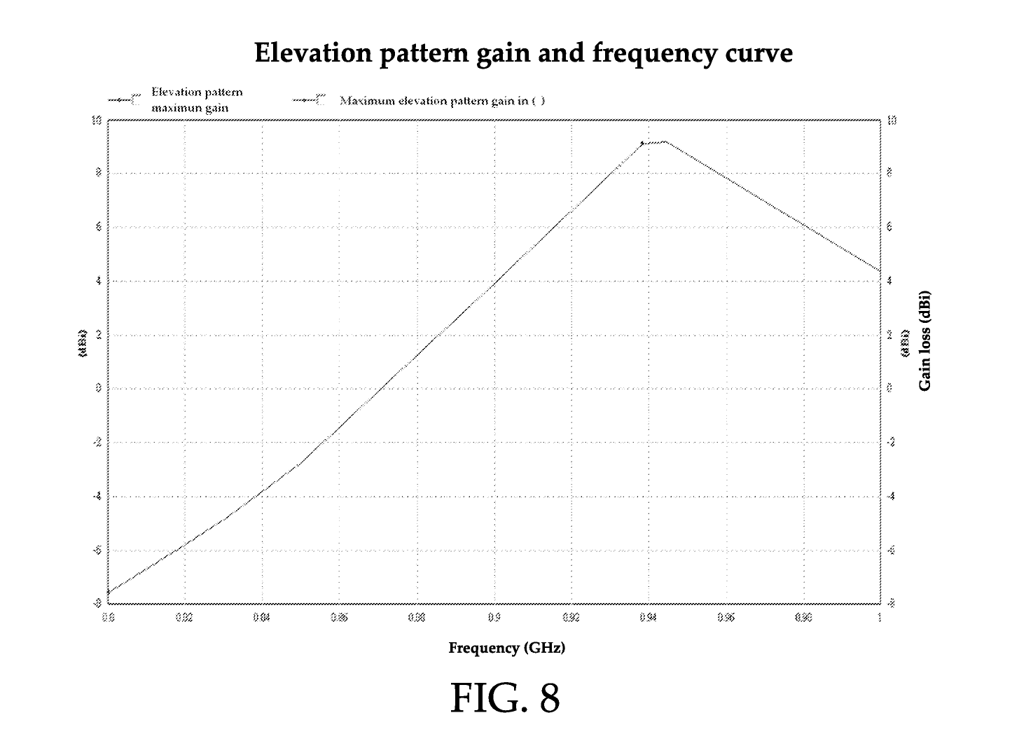

In the embodiment shown in FIG. 3, the diameter of the radiation patch 100 is 71 mm′ the width of the surface current path of the radiation patch 100 is 29 mm; the coordinate value of the feeding point 21 is (X=0, Y=5.14 mm). When tested in the range of 902 MHz˜928 MHz, as illustrated in FIG. 5, the return loss is optimal; the elevation pattern gain display shown in FIG. 6 and the elevation pattern gain and frequency curve shown in FIG. 8 indicate the gain of the test sample of the present invention can reach 8˜9 dBi; FIG. 7 illustrates the antenna efficiency and radiation efficiency of the test sample of the present invention can be as high as over 90%.

In conclusion, the invention provides a surrounded antenna using a phase shifter, which comprises at least one phase shifter located in a surface current path thereof for enhancing radio signal strength. When used in a radio frequency recognition system, the surrounded antenna can significantly extend the operating distance of the system. Further, the phase shifter for length and size impedance matching through the applied operating frequency can be conveniently made in any desired pattern (trademark or mark pattern) for easy identification.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A surrounded antenna, comprising:
a radiation patch comprising a closed slot and a surface current path of a predetermined width surrounding said closed slot;
a phase shifter comprising at least one short-circuit path (short stub) segment and at least one open path (open stub) segment, each said short-circuit path (short stub) segment being connected between two internal contacts of said surface current path, each said open path (open stub) segment comprising opposing connection end and open end, said connection end being to said surface current path;
a grounded patch spaced apart from said radiation patch at a predetermined distance; and
a feeding point located at one said short-circuit path (short stub) segment and connected to said grounded patch through at least one hole.

2. The surrounded antenna as claimed in claim 1, wherein the connection end of each said open path segment is connected to one said internal contact of one said short-circuit path (short stub) segment to which one said short-circuit path (short stub) segment is connected.

3. The surrounded antenna as claimed in claim 1, wherein the connection end of each said open path segment is selectively connected to one of a plurality of contacts of said surface current path.

4. The surrounded antenna as claimed in claim 1, wherein the connection end of said open path segment is selectively connected to one of a plurality of internal contacts of said short-circuit path (short stub) segment.

5. The surrounded antenna as claimed in claim 1, wherein said phase shifter that comprises said at least one short-circuit path (short stub) segment and said at least one open path (open stub) segment constitutes an identification pattern layer in a predetermined pattern for identification.

6. The surrounded antenna as claimed in claim 5, wherein said identification pattern layer is formed of at least one said short-circuit path (short stub) segment and at least one said open path segment.
